(19) United States
(12) Patent Application Publication
(10) Pub. No.: US 2025/0364753 A1
(43) Pub. Date: Nov. 27, 2025

(54) ELECTRICAL PLUG CONNECTION, PLUG CONNECTOR, SET HAVING A PLUG CONNECTOR AND A MATING PLUG CONNECTOR, AS WELL AS HOUSING HAVING AN ELECTRICAL PLUG CONNECTION

(71) Applicant: WAGO Verwaltungsgesellschaft mbH, Minden (DE)

(72) Inventors: Rudolf MASTEL, Minden (DE); Philipp OBER-WOERDER, Kirchlengern (DE)

(73) Assignee: WAGO Verwaltungsgesellschaft mbH, Minden (DE)

(21) Appl. No.: 19/220,010

(22) Filed: May 27, 2025

(30) Foreign Application Priority Data
May 27, 2024 (DE) 20 2024 102 744.2

(51) Int. Cl. H01R 13/635; H01R 13/46; H01R 13/627

(52) U.S. Cl. CPC H01R 13/635; H01R 13/46; H01R 13/6273

(57) ABSTRACT

An electrical plug connection is provided, which has a plug connector, a mating plug connector connectable to the plug connector, and a locking element arranged on the plug connector for mechanically securing the electrical plug connection in a joined-together state of the plug connector and mating plug connector. The locking element has a locking component, which is movable between a locking state and an unlocking state. A plug connector for an electrical plug connection of this type, a set having a plug connector and a mating plug connector, as well as a housing having a housing opening in which an electrical plug connection of this type is arranged are also disclosed.

This nonprovisional application claims priority under 35 U.S.C. § 119 (a) to German Patent Application No. 20 2024 102 744.2, which was filed in Germany on May 27, 2024, and which is herein incorporated by reference.

### BACKGROUND OF THE INVENTION

### Field of the Invention

The invention relates to an electrical plug connection having a plug connector, a mating plug connector connectable to the plug connector, and a locking element arranged on the plug connector for mechanically securing the electrical plug connection in a joined-together state of the plug connector and mating plug connector, the locking element having a locking component which is movable between a locking position and an unlocking position. The invention further relates to a plug connector for an electrical plug connection of this type, a set having a plug connector and a mating plug connector, as well as a housing having a housing opening, in which an electrical plug connection of this type is arranged.

### Description of the Background Art

Lockable plug connectors are known from electrical connecting systems. Plug connectors may be used, for example, as electromechanical connecting components to connect flexible and/or rigid electrical conductors for the purpose of establishing an electrical connection and facilitate an easier handling of conductor connections by connecting to a corresponding mating plug connector. By locking the plug connection with the aid of a locking element, the connections of the plug connector to the mating plug connector may be mechanically secured against an unintentional release.

In practice, installation situations with limit accessibility of the plug connection may occur. Under certain circumstances, a handling of the locking element may be made more difficult hereby.

### SUMMARY OF THE INVENTION

It is therefore an object of the invention to provide an electrical plug connection, which has an improved handling of the plug connection, in particular the locking element.

The object is achieved by an electrical plug connection, a plug connector for an electrical plug connection of this type, a set having a plug connector and a mating plug connector, as well as a housing having an electrical plug connection.

According to an example, a plug connection is proposed, which has a plug connector, a mating plug connector connectable to the plug connector, and a locking element arranged on the plug connector for mechanically securing the electrical plug connection in a joined-together state of the plug connector and mating plug connector, the locking element having a locking component, which is movable between a locking position and an unlocking position, an actuating element having an actuating mechanism being arranged on the mating plug connector, which, when actuated, is configured to effectuate an unlocking of the locking element by moving the locking component into the unlocking position.

This makes it possible to unlock the locking element even if the accessibility of the locking element is limited and thus to be able to release the mating plug connector from the plug connector. Depending on the installation situation, an improved accessibility of the mating plug connector compared to the plug connector may exist, and an unlocking of the locking element may thus be carried out more easily from the mating plug connector side, an unlocking being made possible by the described actuating element on the mating plug connector. In installation situations with more difficult accessibility of the locking element, an unlocking of the plug connection therefore does not have to be dispensed with. Moreover, as explained below on the basis of the example, the actuating element may be structurally adapted to the locking element and its mechanical functionality in such a way that locking elements already available may be used in connection with the invention without any structural modification.

The plug connector and mating plug connector may each have plug contact elements, which are assigned to each other and permit an electrical contacting between the plug connector and the mating plug connector in a connected state of the plug connector to the mating plug connector. In other words, a connection of the plug connector to the mating plug connector may be understood to be an electromechanical connection in which the plug connector and the mating plug connector are mechanically and electrically coupled to each other. The plug connector may be connectable to the mating plug connector in a plug-in direction and be able to be released therefrom in the same axial direction with an opposite direction of movement.

The locking element can have a locking component, which is movable between a locking position and an unlocking position. The locking component may therefore be used to optionally effectuate a locking state of the locking element in the sense of a mechanical securing of the plug connection, in which the plug connector and the mating plug connector are secured against a release from each other, and an unlocking state in the sense of a mechanical release of the plug connection, in which the plug connector and the mating plug connector are able to be released from each other. In principle, the locking component may be configured, for example, to be transferable into the locking position by a manual influence and movable into the unlocking position, supported by an aid, the actuating element being able to provide an aid of this type. A movement of the locking component into the locking position supported by an aid is not ruled out in principle.

The actuating element can have an actuating mechanism, which is configured to effectuate an unlocking of the locking element upon actuation by moving the locking component into the unlocking position. The actuating mechanism may be, in particular, manually actuatable, for example by applying a pressure force or a tensile force to an actuating structure of the actuating mechanism. The actuating mechanism is configured to convert an actuation of this type into a mechanical influencing of the locking component. A conversion of this type may take place directly or indirectly, depending on the structural implementation of the actuating mechanism. For example, it is not ruled out that a separate mechanical actuator is arranged between the actuating element and the locking component. The actuating element may be arranged, for example, on the outside of a mating plug connector housing of the mating plug connector. In particular, the actuating element may be arranged on a housing section of the mating plug connector housing which faces the locking element of the plug connector in a state of the mating plug connector connected to the plug connector. In particular, the actuating element may be arranged in a housing section of the mating plug connector housing which, in a joined-together state of the plug connector and the mating plug connector, abuts a housing region of a plug connector housing on which the locking element is arranged. In other words, the actuating element may be arranged on the mating plug connector in such a way that it is oriented to point toward the locking element in a joined-together state of the plug connector and the mating plug connector. The actuating element may be arranged, for example, on a housing side wall of the mating plug connector, which may extend, for example, orthogonally to a conductor connection side of the mating plug connector and/or orthogonally to a connection actuation side. A conductor connection side may be provided, for example, with conductor connection openings, and a connection actuation side may be provided, for example, with connection actuating elements, such as actuating levers. The plug connector and/or the mating plug connector may each have a spring-force clamping connection for the spring force-supported connection of at least one electrical conductor, a connection actuating element being able to be used, for example, to open and close a clamping point of the spring-force clamping connection. The actuating element may have, for example, an elongated base shape with a main extension along a longitudinal axis in parallel to the above-described plug-in direction of the mating plug connector, so that, during a plugging operation, the mating plug connector may be movable in the direction of the plug connector. and the actuating element may be simultaneously movable in the direction of the locking element. It is conceivable that the plug connector has two or more locking elements and/or the mating plug connector has two or more actuating elements, which may each be arranged, for example on opposite housing sides of the plug connector or the mating plug connector. In this way, a flexible or a particularly reliable mechanical securing may be achieved and flexible unlocking possibilities provided.

The electrical plug connection may be provided for arrangement in a housing opening of a housing, the plug connector, including the locking element arranged thereon, being configured to dip into the housing opening of the housing, and the mating plug connector, including the actuating element arranged thereon, being configured to protrude out of the housing opening, at least in sections. In such an installation situation of the plug connection, a limited accessibility of the plug connector dipping into the housing opening exists, while the mating plug connector protrudes from the housing opening, at least in sections, and a good accessibility of the actuating element is thus given. The advantages described above of an improved handling of the locking element, for example in an installation situation according to the illustrated example, may therefore be achieved. In particular, the plug connector, including the locking element arranged thereon, may be configured to dip predominantly into the housing opening, so that the majority of the plug connector is moved into the housing opening. In particular, the mating plug connector, including the actuating element arranged thereon, may be configured to protrude predominantly out of the housing opening, so that the majority of the plug connector is arranged outside the housing. In other words, the housing opening may lead from housing surroundings of the housing into a housing interior of the housing, and the plug connector may be predominantly arranged in a housing interior of the housing, and the mating plug connector may be arranged predominantly in housing surroundings outside the housing. The housing may be, for example, a device housing of an electrical device. The housing opening may be, for example, a recess in the housing provided specifically for the plug connection. The plug connection may have, for example, installation features, based on which it is possible to determine that the plug connection is provided for arrangement in a housing opening of a housing. For example, the plug connection may have a certain installation shape or installation dimensioning or defined outer installation contours, which may correspond to common or, for example also standardized, installation situations for the arrangement of the plug connection in a housing opening. The plug connector and/or the mating plug connector may have at least one fixing element for fastening or supporting the plug connection on the housing.

The locking element may be designed as a locking latch. A locking latch may be a locking element arrangeable or arranged on a plug connector, including a latch-shaped bracket for engaging with a mating plug connector arranged opposite, the plug connector and the mating plug connector being able to be clamped against each other with the aid of the latch-shaped bracket. A locking latch is a structurally simple locking element, with the aid of which a mechanical interaction with the provided actuating element may be easily produced for unlocking the locking latch. With the aid of the example, a structurally simple and cost-effective locking and unlocking approach may therefore be provided.

The locking component may be designed as a spring-elastic latching tab and be configured to engage with a latching contour of the mating plug connector in the locking position and to be releasable from the engagement with the latching contour in the unlocking position. A releasable latching connection of the locking element on the mating plug connector may therefore be provided for mechanically securing the connection between the plug connector and the mating plug connector. The latching contour on the mating plug connector may be, for example, a latching edge of a latching opening, into which the spring-elastic latching tab may dip and be supported on the latching edge bordering the latching opening, so that an undercut of the latching tab with the latching edge may be formed. In the unlocking position, the latching tab may be situated at a distance from the latching contour, for example bent away therefrom, in such a way that an engagement of the latching tab with the latching contour is undone, and the mating plug connector may be released from the plug connector. Via a spring-elastic latching tab, a reliably effective locking component, which is easily movable between the locking position and the unlocking position, may be used, due to the given spring elasticity.

The locking component may have a release tab connected to the spring-elastic latching tab, with the aid of which the spring-elastic latching tab is movable out of the engagement with the latching contour. A release of the latching tab from the engagement with the latching contour may be made easier hereby. The release tab may be characterized, in particular, by a better accessibility than the latching tab dipping, for example, into a latching opening. The release tab may face, for example, the actuating element, in particular an actuating contour of the mating plug connector described below. It is alternatively or additionally conceivable that the release tab or a further release tab faces an unlocking mechanism described below, in particular an unlocking contour of the locking element. The release tab may have a force application surface for a transfer of force of the actuating mechanism and/or the unlocking mechanism onto the release tab for the purpose of moving the latching tab out of the engagement with the latching contour of the mating plug connector. The release tab may be formed, in particular, as a single piece with the latching tab.

The actuating mechanism may have a movable actuating contour for moving the locking component from the locking position into the unlocking position. A reliably effective actuating mechanism may be achieved hereby. A movable actuating contour may be understood to be a defined actuating section of the actuating element, for example an actuating edge, which is movable relative to the mating plug connector. The movable actuating contour may be movable in the direction of the locking component during an actuation of the actuating mechanism. The actuating contour may be, for example, a lever contour, which is configured to lever the locking component out of an engagement with the mating plug connector. If the locking component is designed, for example, as a latching tab, the movable actuating contour may be guided under the latching table and/or a release table connected to the latching tab during actuation to lever the latching tab out of the engagement with the latching contour of the mating plug connector.

The actuating element may have a base section and an actuating arm connected to the base section for actuating the actuating mechanism, the movable actuating contour being arranged on the actuating arm. An easy-to-operate and reliably effective actuating mechanism may be achieved hereby. A secure joining and support of the actuating element to/on the mating plug connector may be ensured by the base section, an actuating mechanism being able to be implemented via the actuating arm connected to the base section. The movable actuating contour may be formed, for example, on a free end of the actuating arm, while a further end of the actuating arm may be joined to the base section. The actuating arm may have, for example, a curved profile over the base section and be movable onto the base section by pressure force, by which means the movable actuating contour may be displaced in the direction of the locking component of the locking element and move the latter into the unlocking position. The base section may form, for example, a predominantly flat base plate of the actuating element. The actuating contour may be designed, for example, as a lever contour to be able to lever a locking component designed as a latching tab onto the actuating arm out of an engagement with a latching contour of the mating plug connector, in particular against the direction of an applied pressure force. The actuating arm and the movable actuating contour may be designed to be movable relative to the base section of the actuating element. The movable parts of the actuating element, in particular the actuating arm and the movable actuating contour, may form the actuating mechanism of the actuating element. The actuating arm and the base section may be designed to be integral with each other.

The base section of the actuating element may have a base opening and a guide bar spanning the base opening for guiding the movable actuating contour. A precise movement of the locking component may be implemented hereby with the aid of the movable actuating contour. The guide bar may also act as a hold-down device and promote a force deflection for supporting a lever effect, so that, up to the guide bar, a downward movement of the actuating arm in the direction of the base section and an upward movement of the lever contour starting at the guide bar may be effectuated to lever out the latching tab. The base opening may be a material recess in the base section, through which the movable actuating contour present, for example, on the actuating arm may protrude. The base opening may facilitate, for example, a guidance of the movable actuating contour to the locking component, which may be arranged near a housing surface of the mating plug connector in an engagement with a latching contour. The guide bar may limit the base opening. The guide bar may protrude from the base section at an angle, for example orthogonally thereto.

A supporting component may be arranged between the base section and the actuating arm for the purpose of supporting the actuating arm during its actuation. The supporting component may extend between the actuating arm and the base section, for example in a bar-shaped or spherical manner, in particular protrude from the base section or from the actuating arm. The supporting component is used to stabilize the actuating arm during its actuation and to limit its deflection movement in the direction of the base section.

The mating plug connector may have a housing indentation for forming the latching contour and for receiving the movable actuating contour. In addition, an unlocking contour described below may be optionally receivable in the housing indentation. An improved guidance of the movable actuating contour to a locking component designed as a latching tab may be achieved hereby. A protected arrangement of the locking component, the actuating contour, as well as optionally the unlocking contour may also be achieved. The housing indentation may be, in particular, a housing indentation in the mating plug connector housing. The housing indentation may form a local housing recess, which may be also optionally designed as a through-opening, at least in sections. In the housing indentation, the housing surface may be offset to the inside with respect to an adjacent housing surface. In the housing indentation, the movable actuating contour and the locking component designed as a latching tab may extend inwardly, for example in directions facing each other. If an additional unlocking contour is provided, the unlocking contour and the actuating contour may extend to the latching tab arranged therebetween. During the actuation or movement of the actuating contour in the direction of the latching tab or release tab, the actuating contour may be advantageously supported on a surface of the housing indentation.

An unlocking mechanism may be arranged on the locking element, which is configured to effectuate an unlocking of the locking element upon actuation by moving the locking component into the unlocking position. In this example, the locking element may therefore be optionally unlockable with the aid of the actuating mechanism on the mating plug connector side or by the unlocking mechanism on the plug connector side, so that an increased flexibility in handling the plug connection is given. In other words, the locking element may be unlockable with the aid of the unlocking mechanism on the plug connector and/or with the aid of the actuating mechanism on the mating plug connector, depending on a given accessibility and installation situation. This increases the possible uses of the proposed electrical plug connection. In principle, the unlocking mechanism may have a structure comparable to that of the actuating mechanism and a comparable functionality. The unlocking mechanism and the actuating mechanism may be arranged symmetrically in relation to a locking component of the locking element arranged therebetween. The unlocking mechanism and the actuating mechanism may enclose the locking component of the locking element between themselves.

The locking element may have a base section and an unlocking arm joined to the base section with a movable unlocking contour for the purpose of moving the locking component from the locking position into the unlocking position. An easy-to-operate and reliably effective unlocking mechanism may be achieved hereby. A secure joining and support of the locking element to/on the plug connector may be ensured by the base section, an unlocking mechanism being able to be implemented via the unlocking arm connected to the base section. The movable unlocking contour may be formed, for example, on a free end of the unlocking arm, while a further end of the unlocking arm may be joined to the base section. The unlocking arm may have, for example, a curved profile over the base section and be movable onto the base section by pressure force, by which means the movable unlocking contour may be displaced in the direction of the locking component of the locking element and move the latter into the unlocking position. The base section may form, for example, a predominantly flat base plate of the locking element. The unlocking contour may be designed, for example, as a lever contour to be able to lever a locking component designed as a latching tab onto the unlocking arm out of an engagement with a latching contour of the mating plug connector, in particular against the direction of an applied pressure force. The unlocking arm and the movable unlocking contour may be designed to be movable relative to the base section of the locking element. The movable parts of the locking element, in particular the unlocking arm and the movable unlocking contour, may form the unlocking mechanism of the locking element. The unlocking arm and the base section may be designed to be integral with each other.

The locking component may have a first force application surface for mechanically interacting with the unlocking mechanism of the locking element and a second force application surface for mechanically interacting with the actuating mechanism of the actuating element. A compact example may be facilitated hereby. The first force application surface may be used for an application of force by the unlocking mechanism, and the second force application surface may be used for an application of force by the actuating mechanism, to effectuate a movement of the locking component into its unlocking position. If the locking component is designed as a latching tab, the force application surfaces may be arranged, for example, on the latching tab and/or on one or multiple release tabs connected to the latching tab.

The first force application surface may face the movable unlocking contour of the locking element, and the second force application surface may face the movable actuating contour of the actuating element. A targeted and defined application of force for moving the locking component into its unlocking position may be achieved with the aid of the movable unlocking contour and with the aid of the movable actuating contour.

The actuating element may be designed to form a single piece with the mating plug connector. The handling of the proposed plug connection may be made even easier hereby, since, for example, a preceding mounting step for fastening the actuating element on the mating plug connector may be omitted. For example, the actuating element may be injection-molded onto the mating plug connector housing of the mating plug connector.

The actuating element may be detachably connectable or connected to the mating plug connector. A flexible possibility for using the actuating element is achieved hereby. The actuating element may also be arrangeable, for example, on different housing sides of the mating plug connector to facilitate an improved accessibility, depending on the existing installation situation. The actuating element may be connectable to the mating plug connector, for example via a form-fitting connection, by which means an easy, in particular tool-free, mounting is made possible. For example, the actuating element may have a positive form-fitting contour, such as a dovetail contour or a mushroom contour, which may engage with a negative form-fitting mating contour of the mating plug connector or vice versa.

The locking element may be designed to form a single piece with the plug connector. The handling of the proposed plug connection may be made even easier hereby, since, for example, a preceding mounting step for fastening the locking element on the plug connector may be omitted. For example, the locking element may be injection-molded onto a plug connector housing of the plug connector.

The locking element may be detachably connectable or connected to the plug connector. A flexible possibility for using the locking element is achieved hereby. In addition, the locking element may be arrangeable, for example, on different housing sides of the plug connector. The locking element may be connectable to the plug connector, for example via a form-fitting connection, by which means an easy, in particular tool-free, mounting is made possible. For example, the locking element may have a positive form-fitting contour, such as a dovetail contour or a mushroom contour, which may engage with a negative form-fitting mating contour of the plug connector or vice versa.

The plug connector may be designed as a female connector and the mating plug connector as a male connector. Female connectors as plug connector may be more frequently be affected by a more difficult accessibility in confined installation situations, since they are more likely to be arranged in a housing interior than in housing surroundings, depending on the application, in particular according to the flow direction, while an assigned mating plug connector designed as a male connector is more likely to be arranged on the plug connector extending into the housing surroundings with improved accessibility. A particularly practical plug connection is therefore provided with the aid of the example. A female connector may be a conductor connecting element having a spring-elastic contact pin receptacle. A male connector may be a conductor connecting element having one or multiple electrically conductive contact pins. The contact pins of the male connector may be configured for an electrical contacting of the contact pin receptacles of the female connector. According to one design possibility, the female connector may have solder pins for establishing a solder connection and thereby be designed as a so-called female solder connector. The female solder connector may be equipped, in particular, with a locking element formed as a single piece with the female solder connector.

The actuating element and/or the locking element may have a visual and/or haptic identification for distinguishing the actuating element from the locking element. This may apply, in particular, to examples of the locking element in which the locking element is equipped with an unlocking mechanism. An improved, intuitive operation and a rapid ability to detect the locking situation and existing unlocking possibilities may be achieved hereby. For example, an unlocking arm of the locking element may have a ribbed surface, while an actuating arm of the actuating element may have a smooth surface, or vice versa. The unlocking arm and the actuating arm may alternatively or additionally have basic shapes, dimensioning, or colorings deviating from each other.

The invention further relates to a mating plug connector for an electrical plug connection according to one of the features described above, an actuating element having an actuating mechanism being arranged on the mating plug connector, which is configured to effectuate, upon actuation, an unlocking of a locking element arranged on a plug connector connectable to the mating plug connector by moving a locking component of the locking element which is movable between a locking position and an

The above-described advantages of an improved handling of plug connections and locking elements with limited accessibility may also be achieved with the aid of the proposed mating plug connector. With the aid of the mating plug connector and the actuating element arranged thereon, it is possible to reliably and comfortably unlock a locking element of a plug connector with limited accessibility.

The invention furthermore relates to a set having a plug connector and a mating plug connector, which are configured to form an electrical plug connection according to one of the features described above in an assembled state. The above-described advantages of an improved handling of plug connections and locking elements with limited accessibility may also be achieved with the aid of the proposed set having a plug connector and a mating plug connector.

The set may have a separate locking element which is detachably connectable to the plug connector. A flexible possibility for using the locking element is achieved hereby. In addition, the locking element may be arrangeable, for example, on different housing sides of the plug connector. The locking element may be connectable to the plug connector, for example via a form-fitting connection, by which means an easy, in particular tool-free, mounting is made possible. For example, the locking element may have a positive form-fitting contour, such as a dovetail contour or a mushroom contour, which may engage with a negative form-fitting mating contour of the plug connector or vice versa. According to an example, it is however also conceivable, in principle, that the locking element is designed to form a single piece with the plug connector.

The set may have a separate actuating element which is detachably connectable to the plug connector. A flexible possibility for using the actuating element is achieved hereby. The actuating element may also be arrangeable, for example, on different housing sides of the mating plug connector to facilitate an improved accessibility, depending on the existing installation situation. The actuating element may be connectable to the mating plug connector, for example via a form-fitting connection, by which means an easy, in particular tool-free, mounting is made possible. For example, the actuating element may have a positive form-fitting contour, such as a dovetail contour or a mushroom contour, which may engage with a negative form-fitting mating contour of the mating plug connector or vice versa. According to an example, it is however also conceivable, in principle, that the actuating element is designed to form a single piece with the plug connector.

The invention also relates to a housing having a housing opening in which an electrical plug connection according to one of the features described above is arranged, a plug connector of the electrical plug connection, including a locking element arranged on the plug connector, dipping into the housing opening, and a mating plug connector of the electrical plug connection, including an actuating element arranged on the mating plug connector, protruding out of the housing opening. In such an installation situation, a limited accessibility of the plug connector dipping into the housing opening is present, while the mating plug connector protrudes out of the housing opening, at least in sections, and a good accessibility of the actuating element is thus given. The advantages described above of an improved handling of the locking element may therefore be achieved, in particular in the case of the housing described above. In particular, the plug connector, including the locking element arranged thereon, may be configured to dip predominantly into the housing opening, so that the majority of the plug connector is moved into the housing opening. In particular, the mating plug connector, including the actuating element arranged thereon, may be configured to protrude predominantly out of the housing opening, so that the majority of the plug connector is arranged outside the housing. In other words, the housing opening may lead from housing surroundings of the housing into a housing interior of the housing, and the plug connector may be predominantly arranged in a housing interior of the housing, and the mating plug connector may be arranged predominantly in housing surroundings outside the housing. The housing may be, for example, a device housing of an electrical device. The housing opening may be, for example, a recess in the housing provided specifically for the plug connection. The plug connection may have, for example, installation features, based on which it is possible to determine that the plug connection is provided for arrangement in a housing opening of a housing. For example, the plug connection may have a certain installation shape or installation dimensioning or defined outer installation contours, which may correspond to common or, for example also standardized, installation situations for the arrangement of the plug connection in a housing opening. The plug connector and/or the mating plug connector may have at least one fixing element for fastening or supporting the plug connection on the housing.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a schematically shows a cutaway top view of an electrical plug connection arranged in a housing opening of a housing, according to an example;

FIG. 1b schematically shows an enlarged detailed view of the arrangement illustrated in FIG. 1a;

FIG. 2 schematically shows a first perspective side view of the arrangement illustrated in FIG. 1a;

FIG. 3 schematically shows a side view of the arrangement illustrated in FIG. 1a;

FIG. 4 schematically shows a second perspective side view of the arrangement illustrated in FIG. 1a;

FIG. 5 schematically shows a third perspective side view of the arrangement illustrated in FIG. 1a with the actuating elements of the plug connection not displayed;

FIG. 6 schematically shows a rear-side perspective view of a mating plug connector of the plug connection according to FIG. 1;

FIG. 7 schematically shows a front-side perspective view of the mating plug connector according to FIG. 6;

FIG. 8 schematically shows a front-side perspective view of a plug connector for an electrical plug connection according to an example;

FIG. 9 schematically shows a front-side perspective view of a plug connector for a plug connection according to an example; and

FIG. 10 schematically shows a front-side perspective view of a plug connector for an electrical plug connection according to an example.

### DETAILED DESCRIPTION

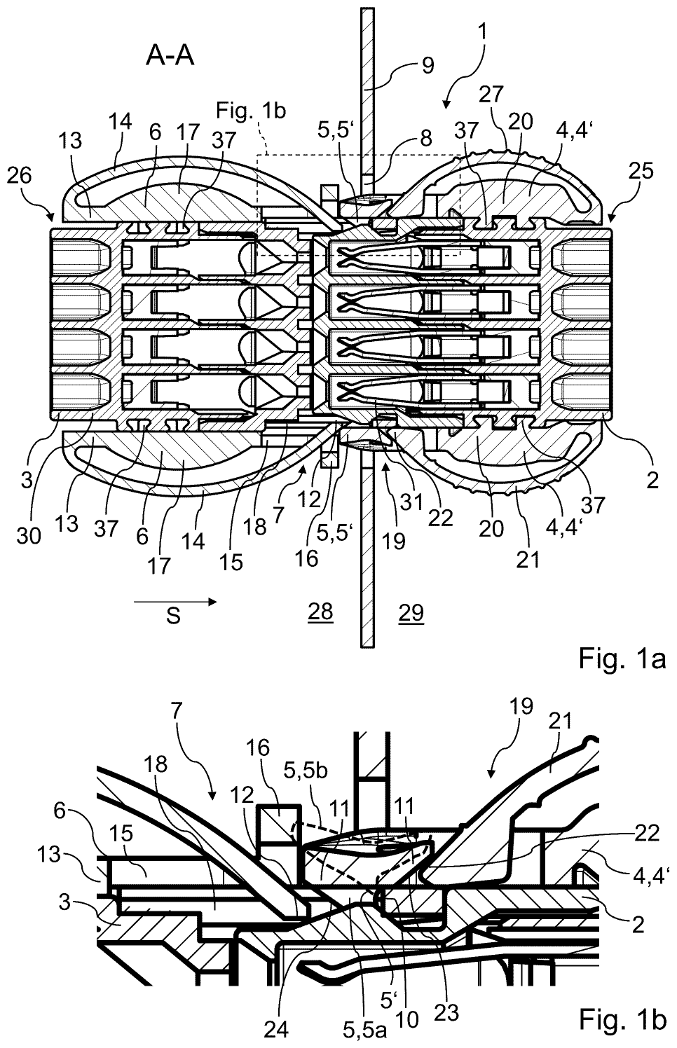

FIG. 1a shows a sectional representation of a four-pin electrical plug connection 1 arranged in a housing opening 8 of a housing 9 along a plane of intersection A-A illustrated in FIG. 3. FIG. 1b shows an enlarged detailed representation of the image section framed by the dashed line in FIG. 1a.

Electrical plug connection 1 has a plug connector 2 and a mating plug connector 3 connectable to plug connector 2. Plug connector 2 is connectable to mating plug connector 3 in a plug-in direction S illustrated in FIG. 1a and may be released therefrom in the same axial direction with an opposite direction of movement. A locking element 4 is arranged on plug connector 2 on each of two opposite housing side walls of plug connector 2 for the purpose of mechanically securing electrical plug connection 1 in a joined-together state of plug connector 2 and mating plug connector 3. In principle, it is also conceivable to arrange only one locking element 4 or also more than two locking elements 4 on plug connector 2. Locking element 4 designed as a locking latch 4′ in each of the illustrated figures have a locking component 5, which is movable between a locking position 5a illustrated in FIG. 1b and an unlocking position 5b illustrated by the dashed line in FIG. 1b. By locking electrical plug connection 1, the connection of plug connector 2 to mating plug connector 3 may be mechanically secured against an unintentional release.

Opposite each locking element 4, an actuating element 6 having an actuating mechanism 7 is arranged in each case on mating plug connector 3, which is configured to effectuate an unlocking of locking element 4 upon actuation by moving locking component 5 into unlocking position 5b. This makes it possible to unlock locking element 4 even if the accessibility of locking element 4 is limited and thus be able to release mating plug connector 3 from plug connector 2. In installation situations with more difficult accessibility of locking element 4, an unlocking of plug connection 1 therefore does not have to be dispensed with. In principle, it is also conceivable to arrange only one actuating element 6 or also more than two actuating elements 6 on mating plug connector 3, it being possible to advantageously arrange one actuating element 6 on each locking element 4. Actuating elements 6 are arranged on a mating plug connector housing 30 of mating plug connector 3.

As is apparent in FIG. 1a, plug connector 2 of electrical plug connection 1, including locking element 4 arranged on plug connector 2, dips into housing opening 8, while mating plug connector 3 of electrical plug connection 1, including actuating elements 6 arranged on mating plug connector 3, protrudes out of housing opening 8. Accordingly, mating plug connector 3 is arranged predominantly in housing surroundings 28 outside housing 9 and is thus easily accessible, while plug connector 2 is arranged predominantly in a housing interior 29 and is thus inaccessible or has limited accessibility, depending on the installation situation. With the aid of actuating elements 6, it is nevertheless possible to unlock locking elements 4 on plug connector 2 and thus establish an ability to release mating plug connector 3 from plug connector 2.

As is apparent from FIGS. 1a and 1b, locking component 5 is designed as a spring-elastic latching tab 5′ and is configured to engage with a latching contour 10 of mating plug connector 3 in locking position 5a and to be released from the engagement with latching contour 10 in unlocking position 5b. A releasable latching connection between locking element 4 and mating plug connector 3 may therefore be able to be established, an easy-to-move locking component 5 being formed with spring-elastic latching tab 5′. In unlocking position 5b, movable locking component 5 is moved away from plug connector 2 or from its surface. According to the illustrated example, latching contour 10 is designed as a latching edge of a latching opening in mating plug connector housing 30, into which spring-elastic latching tab 5′ may dip and be supported on the latching edge bordering the latching opening. As indicated in FIG. 1b, latching tab 5′ may be situated at a distance from latching contour 10 in unlocking position 5b, so that an engagement of latching tab 5′ with latching contour 10 is undone, and mating plug connector 3 may be released from plug connector 2.

It is furthermore apparent in FIG. 1b that locking component 5 has a release tab 11 connected to spring-elastic latching tab 5′, with the aid of which spring-elastic latching tab 5′ is movable out of the engagement with latching contour 10. A release of latching tab 5′ from the engagement with latching contour 10 may be made easier hereby. It is apparent in FIG. 1b that actuating mechanisms 7 of actuating elements 6 each have a movable actuating contour 12 for moving locking component 5 designed as latching tab 5′ from locking position 5a into unlocking position 5b. Movable actuating contour 12 may face a release tab 11. Movable actuating contour 12 forms an actuating edge, which may lever latching tab 5′ out of the engagement with latching contour 10 via release tab 11. For this purpose, movable actuating contour 12 may be guided under release tab 11 and may lift it via a levering movement.

During the movement in the direction of plug connector 2, actuating contour 12 may slide on a sloping surface of the plug connector housing in the direction of locking component 5, by which means the levering movement is supported.

It is further apparent from FIGS. 1a and 1b that actuating elements 6 each have a base section 13 and an actuating arm 14 connected to base section 13 for actuating particular actuating mechanism 7, movable actuating contour 12 being arranged on particular actuating arm 14. Movable actuating contour 12 is formed on a free end of actuating arm 14, while a further end of actuating arm 14 is joined to base section 13. Actuating arm 14 has a curved profile over base section 13 and is movable onto base section 13 by pressure force, by which means movable actuating contour 12 may be displaced in the direction of latching tab 5′ and move the latter into unlocking position 5b. According to the illustrated example, actuating arm 14 and base section 13 are designed to be integral with each other.

According to the illustration in FIG. 1a, a spherical supporting component 17 designed to be integral with base section 13 is formed between base section 13 and actuating arm 14 for the purpose of supporting actuating arm 14 during its actuation. This stabilizes actuating arm 14 during its actuation and limits its deflection movement in the direction of base section 13. It is moreover apparent from FIGS. 1a and 1b that mating plug connector 3 has a housing indentation 18 in mating plug connector housing 30 for forming latching contour 10 and for receiving movable actuating contour 12. An improved guidance of movable actuating contour 12 to latching tab 5′ may be achieved hereby.

According to the example illustrated in FIGS. 1a and 1b, an unlocking mechanism 19 is arranged on each of the locking elements 4, which is configured to effectuate an unlocking of locking element 4 upon actuation by moving locking component 5 into unlocking position 5b. Accordingly, locking element 4 may be optionally unlockable with the aid of actuating mechanism 7 or with the aid of unlocking mechanism 19, so that an increased flexibility in handling plug connection 1 is given. As is apparent from FIG. 1a, actuating mechanism 7 and unlocking mechanism 19 may have a comparable structure and a comparable functionality. As illustrated in FIG. 1a, actuating mechanism 7 and unlocking mechanism 19 may also be arranged essentially symmetrically in relation to locking component 5 and enclose the latter between themselves. Locking elements 4 have a base section 20 and an unlocking arm 21 connected to base section 20, including a movable unlocking contour 22 for moving locking component 5 from locking position 5a into unlocking position 5b, so that unlocking mechanism 19 is reliably effective and easy to operate. As illustrated, unlocking arm 21 may have a curved profile over base section 20 and is movable onto base section 20 by pressure force, by which means movable unlocking contour 22 may be displaced in the direction of latching tab 5′ and move the latter out of the engagement with latching contour 10 into unlocking position 5b. According to the illustrated example, unlocking arm 21 and base section 20 are designed to be integral with each other.

It is apparent in FIG. 1b that locking component 5 designed as a latching tab 5′ has a first force application surface 23 for mechanically interacting with unlocking mechanism 19. For this purpose, this first force application surface 23 faces movable unlocking contour 22 of locking element 4. Locking component 5 also has a second force application surface 24 for mechanically interacting with actuating mechanism 7 of actuating element 6, which faces movable actuating contour 12 of actuating element 6 for this purpose. A targeted and defined application of force on locking component 5 is therefore made possible for moving it into unlocking position 5b.

As is apparent, for example, in FIG. 1a, actuating elements 6 are detachably connected to mating plug contour 3. For this purpose, actuating elements 6 have a form-fitting contour 37 on their base section 13, which may engage with a corresponding form-fitting mating contour 38 of mating plug connector 3 or mating plug connector housing 30, as is apparent in FIG. 5. This enables actuating elements 6 to be easily fastened on mating plug connector 3, in particular without tools. It is, in principle, also conceivable to form at least one actuating element 6 as a single piece with mating plug connector 3, for example to injection-mold it onto mating plug connector housing 30.

It is furthermore apparent in FIG. 1a that locking elements 4 are detachably connected to plug connector 2. For this purpose, locking elements 4 have a form-fitting contour 37 on their base section 20, which may engage with a corresponding form-fitting mating contour of plug connector 2 or the housing of plug connector 2. This enables locking elements 4 to be easily fastened to plug connector 2, in particular without tools. It is, in principle, also conceivable to form at least one locking element 4 as a single piece with plug connector 2.

As is apparent, for example, in FIG. 1a, plug connector 2 is designed as a female connector 25 and mating plug connector 3 as a male connector 26. A particularly practical plug connection 1 is provided hereby, since female connectors 25 as plug connectors 2 are more likely to be arranged in inaccessible housing interior 29 than in housing surroundings 28, due to the flow direction. Female connector 25 and male connector 26 have plug contact elements assigned to each other in the form of contact pins on male connector 26 and contact pin receptacles 31 on female connector 25.

It is moreover apparent in FIG. 1a, among other things, that actuating elements 6 and locking elements 4 may be distinguished from each other by a visually and haptically detectable identification 27, in this case in the form of a comparatively smooth surface of actuating arm 14 and a ribbed surface of unlocking arm 21. An ability to quickly detect a locking situation and existing unlocking possibilities is achieved hereby.

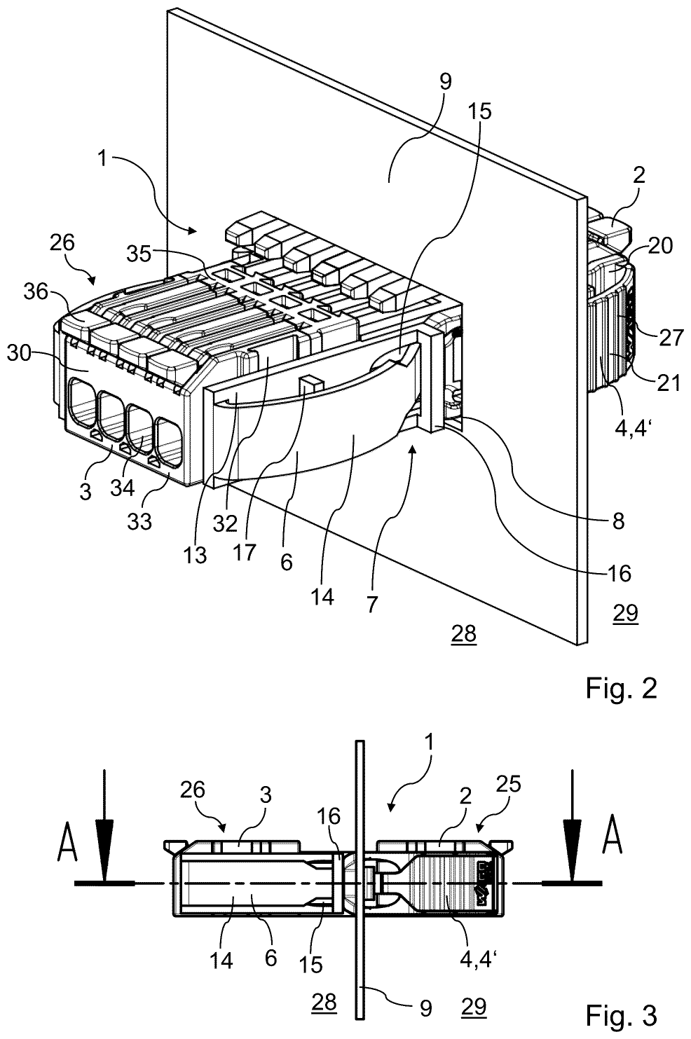

FIG. 2 shows a perspective side view of the arrangement illustrated in FIG. 1a with a viewing direction from housing surroundings 28 toward mating plug connector 3. It is clear in FIG. 2 that base section 13 of actuating element 6 has a base opening 15 and a guide bar 16 spanning base opening 15 for guiding movable actuating contour 12 of actuating mechanism 7. This makes it possible to achieve a precise movement of locking component 5 and to support a lever effect of movable actuating contour 12. According to the illustrated example, guide bar 16 protrudes essentially orthogonally from base section 13. It is further apparent that a bar-shaped supporting component 17 is arranged between base section 13 and actuating arm 14 for the purpose of supporting actuating arm 14 during its actuation. This stabilizes actuating arm 14 during its actuation and limits its deflection movement in the direction of base section 13.

It is also apparent from FIG. 2 that actuating element 6 may be arranged on a housing side wall 32 of mating plug connector housing 30. As illustrated, housing side wall 32 may be a housing wall which extends essentially orthogonally to a conductor connection side 33 having conductor connection openings 34 and essentially orthogonally to a connection actuation side 35 having connection actuating elements 36.

FIG. 3 shows a side view of the arrangement illustrated in FIG. 1a, in which the arrangement of actuating element 6 and locking element 4 situated opposite each other and facing each other is clear. It is also apparent hat actuating element 6 has an elongated basic shape. It is furthermore apparent that locking element 4 is designed as a locking latch 4′.

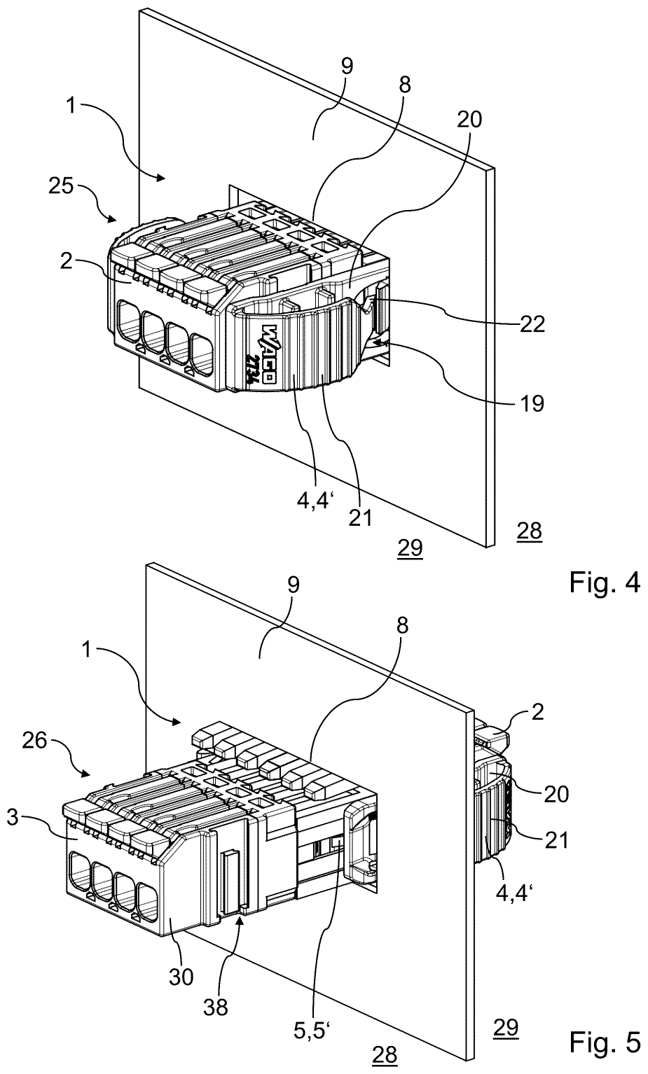

FIG. 4 shows a perspective side view of the arrangement illustrated in FIG. 1a with a viewing direction from housing surroundings 29 toward plug connector 2. Locking element 4 arranged on plug connector 2 and having base section 20, unlocking mechanism 19, and unlocking contour 22 are apparent.

FIG. 5 shows a further perspective side view of the arrangement illustrated in FIG. 1a with a viewing direction from housing surroundings 28 toward mating plug connector 3, actuating elements 6 not being displayed in the illustrated view. Form-fitting mating contour 38 in mating plug connector housing 30 is apparent hereby, which may interact in a form-fitting manner with form-fitting contour 37 of detachably connectable actuating element 6. A possible positioning of locking component 5 with respect to mating plug connector 3 is furthermore apparent.

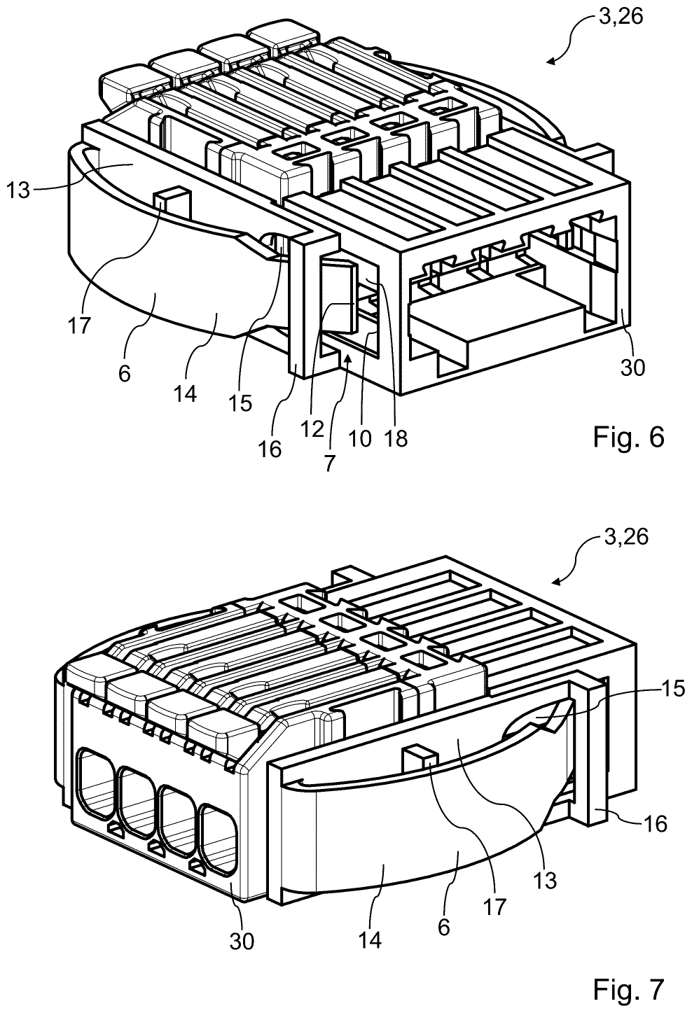

FIGS. 6 and 7 show a back-side and a front-side perspective view of mating plug connector 3 for electrical plug connection 1 according to the preceding figures. It is apparent from FIGS. 6 and 7 that base section 13 of an actuating element 6 has a base opening 15 and a guide bar 16 spanning base opening 15 for guiding movable actuating contour 12. It is moreover apparent that plug connector housing 30 has a housing indentation 18 for forming latching contour 10 and for receiving and guiding movable actuating contour 12, housing indention 18 being designed as a through-opening, at least in sections.

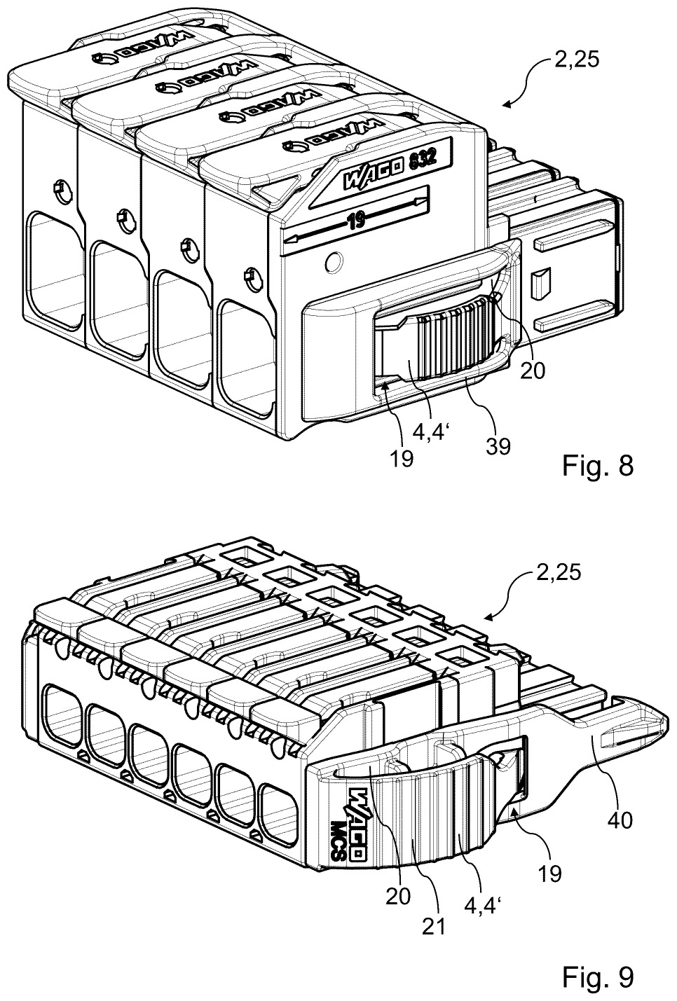

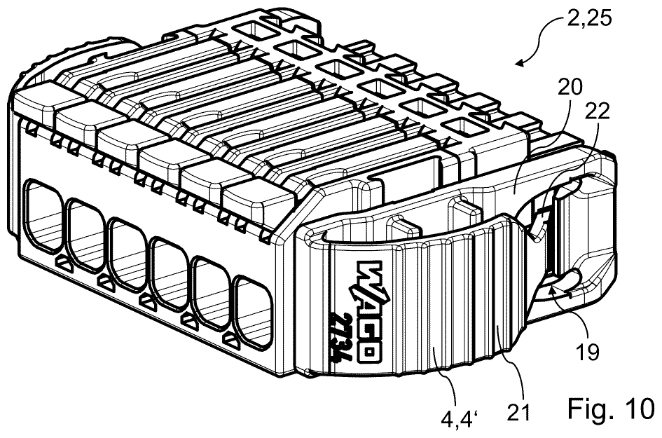

FIGS. 8 through 10 each show a front-side perspective view of a plug connector 2 for an electrical plug connection 1 according to a second, third, and fourth example to clarify that different types and shapes of plug connectors 2 and locking elements 4 may be used in connection with the invention. In FIG. 8, for example, a further four-pin plug connector 2 having a deviating design of locking element 4 is shown, which, according to the illustrated representation, has a frame structure 39 which makes handling easier and increases a mechanical protection. FIG. 9 shows a six-pin plug connector 2 having a deviating design of locking element 4, which, according to the illustrated representation, has an additional latching element 40 for an increased securing effect. FIG. 10 shows a six-pin plug connector 2 having a locking element 4, which has a comparable structure to plug connector 2 illustrated, for example, in FIG. 4. Locking components 5 of locking elements 4 of described plug connector 2 may each be movable into an unlocking position 5b with the aid of described actuating element 6, similarly to the above remarks.

A set for an electrical plug connection 1 may be advantageously formed with the aid of plug connectors 2 and mating plug connectors 3 illustrated in FIGS. 1a through 10. In addition, the set may optionally have at least one locking element 4 detachably connectable to plug connector 2 and optionally at least one actuating element 6 detachably connectable to mating plug connector 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical plug connection comprising:
a plug connector;
a mating plug connector connectable to the plug connector; and
a locking element arranged on the plug connector to mechanically secure the electrical plug connection in a joined-together state of the plug connector and mating plug connector, the locking element having a locking component that is movable between a locking position and an unlocking position; and
an actuating element having an actuating mechanism that is arranged on the mating plug connector, which, when actuated, is configured to effectuate an unlocking of the locking element by moving the locking component into the unlocking position.

2. The electrical plug connection according to claim 1, wherein the electrical plug connection is provided for arrangement in a housing opening of a housing, the plug connector, including the locking element arranged thereon, being configured to dip into the housing opening of the housing, and the mating plug connector, including the actuating element arranged thereon, being configured to protrude out of the housing opening, at least in sections.

3. The electrical plug connection according to claim 1, wherein the locking element is a locking latch.

4. The electrical plug connection according to claim 1, wherein the locking component is a spring-elastic latching tab and is configured to engage with a latching contour of the mating plug connector in the locking position and is releasable from the engagement with the latching contour in the unlocking position.

5. The electrical plug connection according to claim 4, wherein the locking component has a release tab connected to the spring-elastic latching tab, with the aid of which the spring-elastic latching tab is movable out of the engagement with the latching contour.

6. The electrical plug connection according to claim 1, wherein the actuating mechanism has a movable actuating contour for moving the locking component from the locking position into the unlocking position.

7. The electrical plug connection according to claim 6, wherein the actuating element has a base section and an actuating arm connected to the base section for actuating the actuating mechanism, and wherein the movable actuating contour is arranged on the actuating arm.

8. The electrical plug connection according to claim 7, wherein the base section of the actuating element has a base opening and a guide bar spanning the base opening for guiding the movable actuating contour.

9. The electrical plug connection according to claim 7, wherein a supporting component is arranged between the base section and the actuating arm to support the actuating arm during an actuation.

10. The electrical plug connection according to claim 4, wherein the mating plug connector has a housing indentation for forming the latching contour and for receiving the movable actuating contour.

11. The electrical plug connection according to claim 1, wherein an unlocking mechanism is arranged on the locking element, which is configured to effectuate an unlocking of the locking element upon actuation by moving the locking component into the unlocking position.

12. The electrical plug connection according to claim 11, wherein the locking element has a base section and an unlocking arm connected to the base section with a movable unlocking contour to move the locking component from the locking position into the

13. The electrical plug connection according to claim 11, wherein the locking component has a first force application surface to mechanically interact with the unlocking mechanism of the locking element and a second force application surface to mechanically interact with the actuating mechanism of the actuating element.

14. The electrical plug connection according to claim 13, wherein the first force application surface faces the movable unlocking contour of the locking element, and wherein the second force application surface faces the movable actuating contour of the actuating element.

15. The electrical plug connection according to claim 1, wherein the actuating element forms a single piece with the mating plug connector.

16. The electrical plug connection according to claim 1, wherein the actuating element is detachably connectable or connected to the mating plug connector.

17. The electrical plug connection according to claim 1, wherein the locking element forms a single piece with the plug connector.

18. The electrical plug connection according to claim 1, wherein the locking element is detachably connectable or connected to the plug connector.

19. The electrical plug connection according to claim 1, wherein the plug connector is a female connector and the mating plug connector is a male connector.

20. The electrical plug connection according to claim 1, wherein the actuating element and/or the locking element have a visual and/or haptic identification for distinguishing the actuating element from the locking element.

21. A mating plug connector for the electrical plug connection according to claim 1, wherein the actuating element having the actuating mechanism is arranged on the mating plug connector, which is configured to effectuate, upon actuation, an unlocking of a locking element arranged on the plug connector connectable to the mating plug connector by moving a locking component of the locking element which is movable between a locking position and an unlocking position.

22. A set comprising a plug connector and a mating plug connector, which are configured to form the electrical plug connection according to claim 1 in an assembled state.

23. The set according to claim 22, wherein the set has a separate locking element which is detachably connectable to the plug connector.

24. The set according to claim 22, wherein the set has a separate actuating element which is detachably connectable to the mating plug connector.

25. A housing comprising a housing opening, in which the electrical plug connection according to claim 1 is arranged, wherein the plug connector of the electrical plug connection, including the locking element arranged on the plug connector, dips into the housing opening, and a mating plug connector of the electrical plug connection, including the actuating element arranged on the mating plug connector, protrudes out of the housing opening.
